(19) United States
(12) Patent Application Publication
(10) Pub. No.: US 2015/0152848 A1
(43) Pub. Date: Jun. 4, 2015

(54) Omnidirectional Hybrid Turbine Generator

(71) Applicant: Gregory Victor Sustarsic, Redondo Beach, CA (US)

(72) Inventor: Gregory Victor Sustarsic, Redondo Beach, CA (US)

(21) Appl. No.: 14/093,480

(22) Filed: Dec. 1, 2013

(51) Int. Cl. F03D 9/00

(52) U.S. Cl. CPC F03D 9/002

(57) ABSTRACT

An Omnidirectional Hybrid Turbine Generator is provided. The system includes three main components: An omnidirectional turbine blade assembly that can be powered by air currents, air turbulence, ocean currents, waves, tidal currents or river currents; a tower which contains one or more generators and a base that contains another generator along with all the necessary electronics and subsystems.

### FIELD OF THE INVENTION

The invention is a wind powered turbine and/or an ocean current powered turbine. More particular, it is an omnidirectional hybrid turbine. The invention consists of three major components; vertically mounted blades, a support tower that houses generators and other components and a tower base that houses a larger generator along with all other necessary equipment.

### BACKGROUND ART

Most wind turbines are generally described as Horizontal Axis Wind Turbines (HAWT) or Vertical Axis Wind Turbines (VAWT) which have multiple turbine blades hanging off small propeller shafts or multiple struts and use complex hydraulic systems to adjust blade deflection angle for optimal performance. The HAWT's generally have the turbine blades, propeller shaft, generator and most other components balanced on the top of a high tower which ultimately limits the size and capacity of the generator. The VAWT's generally have a more complex array of frames, support structures, struts, gears and blade adjustment systems that don't really provide any advantage or improvement in cost effectiveness (cost per megawatt generated) or durability over the HAWT's.

### SUMMARY OF THE INVENTION

This Omnidirectional Hybrid Turbine Generator invention is created to be powered by currents, either air currents (i.e. wind) or by ocean currents. This turbine is engineered to have fewer moving parts, increased generator capacity and improved stability. Fewer moving parts mean fewer things can wear out and less maintenance is required. Increased generator capacity that does not have to be balanced hundreds of meters high on top of a tower means electrical generating capacity is limited only by the power of the wind or ocean currents, not the size of the generator compartment. The shape and configuration of the rotor blade assembly creates an omnidirectional turbine, meaning it has no front, back or sides, it works in all directions. Thus, the direction the wind or water current doesn't matter, or how quickly or often the currents change direction, the turbine will turn. This means more hours of electrical generation at optimal capacity. More electricity generated per hour with less down time for maintenance will reduce the cost of megawatts generated. This makes wind and ocean current power more competitive with power plants using coal, natural gas or nuclear power.

One embodiment of this omnidirectional hybrid turbine includes a base 1 for the turbine, a generator 2, electronics system and a brake 3 (for maintenance) in that base. On top of the base is the tower 4 structure and contained in the tower would be a rotor shaft 5, mid-tower bearings and seals 7, one or more generators 6 with mounting brackets, a clutch and gearbox, electrical cabling and other needed electronics. The generators engage the rotor shaft via the clutch and gearbox to produce electricity. A rotor hub 9 is mounted inside the rotor 10 at the top. Another set of bearings and seals 8 are at the top rim of the tower 4 and the rotor 10 is mounted on the tower 4. The rotor shaft 5 is connected to the rotor hub 9. The turbine blades 13 are mounted vertically on the outer surface of the rotor 10. Built into the turbine base 1 and the top of the turbine rotor 10 are cooling vents and access doors for maintenance. For the ocean current powered turbine, the access doors would be fitted with airlocks and the cooling vents would be omitted.

### BRIEF DESCRIPTION OF THE DRAWINGS

FIG. 1 is an isometric view of this invention, the Omnidirectional Hybrid Turbine Generator shown with a five blade configuration.

FIG. 2A is an exploded view of the omnidirectional hybrid turbine construction in accordance with an embodiment of this invention, excluding the blades.

FIG. 2B is a cut-away view of the fully assembled omnidirectional hybrid turbine in accordance with an embodiment of this invention, excluding the blades.

FIG. 3 is an enlarged view of FIG. 2B showing the tower section in highlight with the bolder black line as to enhance clarity of the order of assembly.

FIG. 4A is an exploded, isometric, front facing power side view of a turbine blade.

FIG. 4B is an isometric, front facing power side view of a turbine blade.

FIG. 4C is an exploded, isometric, back facing, return side view of a turbine blade.

FIG. 4D is an isometric, back facing, return side view of a turbine blade.

FIG. 5A is an exploded top view of a rotor and five turbine blade assembly in accordance with an embodiment of this invention.

FIG. 5B is an overhead view of a rotor and five turbine blade assembly in accordance with an embodiment of this invention.

FIG. 6A is an exploded isometric view of a rotor and five turbine blade assembly in accordance with an embodiment of this invention.

FIG. 6B is an isometric view of a rotor and five turbine blade assembly in accordance with an embodiment of this invention.

FIG. 7 is an isometric view of the turbine base and tower assembly.

FIG. 8 is an isometric view of the fully assembled omnidirectional hybrid turbine.

FIG. 9A is an isometric view of the rotor blade assembly without the end-caps.

FIG. 9B is an isometric view of the rotor blade assembly with the end-caps.

FIG. 10A is an exploded, overhead view of an alternate fabrication process for the blade and rotor assembly.

FIG. 10B is an overhead view of the alternate fabrication for the blade and rotor assembly process.

FIG. 11A is an overhead cross section view of the turbine rotor with a five blade configuration with the dashed lines representing a transparent view through the top end-caps of the rotor blades. The arrows represent the direction of the wind or water current and the fluid dynamics acting upon the different parts of the blades.

FIG. 11B is an overhead cross section view of the turbine rotor with a five blade configuration at a slightly different rotational angle than FIG. 11A. The arrows represent the direction of the wind or water current and the fluid dynamics acting upon the different parts of the blades. The dotted circular arrows show the directional rotation of the omnidirectional hybrid turbine.

FIG. 11C is an overhead view of the turbine rotor with a five blade configuration with a slightly different rotational angle than FIG. 11A and FIG. 11B. The arrows represent the direction of the wind or water current and the fluid dynamics acting upon the different parts of the blades.

FIG. 12 is a Dual Omnidirectional Hybrid Floating Turbine.

### REFERENCE CHARACTERS

1-Base, 2-Generator for the base, 3-Brake, 4-Tower, 5-Rotor Shaft, 6-Generators for the tower, 7-Bearings and seals for mid-section of the tower, 8-Bearings and seals for top of tower, 9-Rotor Hub, 10-Rotor, 11-Mid-section view of Rotor Blades, 12-End-Cap sections of turbine rotor blade, 13-Turbine Rotor Blades, 14-is an alternate fabrication process for the Blade and Rotor Assembly.

### DETAILED DESCRIPTION OF THE EMBODIMENTS

The detailed description of the embodiment of the invention will be described below with reference to the drawings which illustrate specific embodiments in which the technology can be practiced. The embodiments are intended to describe aspects of the technology in sufficient detail to enable those skilled in the art to practice them. Other embodiments can be utilized and changes can be made without departing from the scope of the technology. Therefore the following detailed description is not to be taken in a limiting sense.

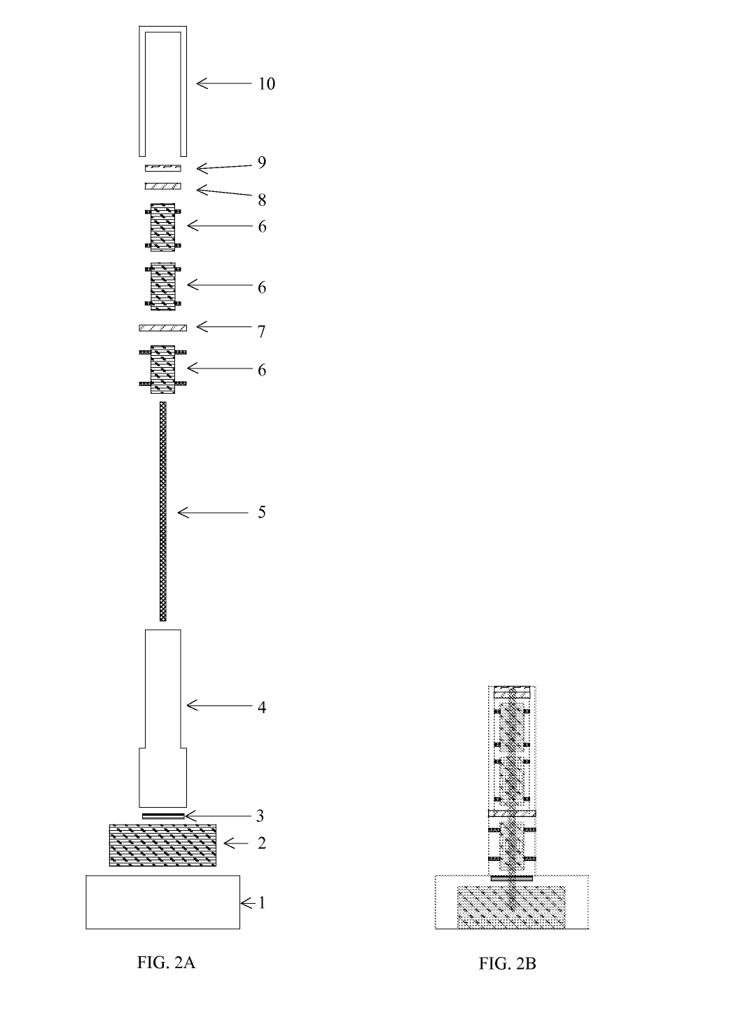

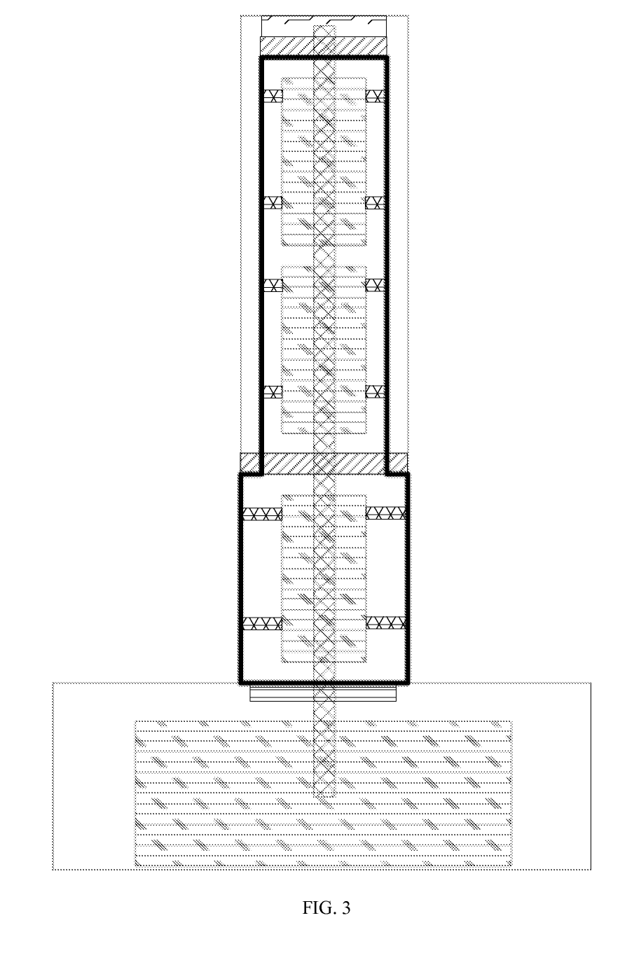

In this embodiment the base and tower will be described using FIGS. 2A, 2B and 3. The Base 1 for the tower is a large building that contains a Generator 2, a Brake 3 that is used to stop the rotor for maintenance purposes, along with other necessary electronics. The Tower 4 will be attached to the top of the Base 1. The other three Generators 6 are lowered into the tower and mounted to the inner wall. The Rotor Shaft 5 is lowered down through the Tower 4 and Base 1 and connected to all of the generators 2 and 6. As highlighted with the bold black lines in FIG. 3 the Tower 4 is cylindrical with the diameter wider at the bottom portion and slightly narrower at the top portion. This shape is to accommodate the Mid-Tower Bearings and Seals 7 to be placed over the top of the tower into the mid-tower bearing seat. The Bearings and Seals 8 for the top of the tower are installed in the bearing seat at the top of the tower. The Rotor Hub 9 is mounted inside of the Rotor 10 at the top.

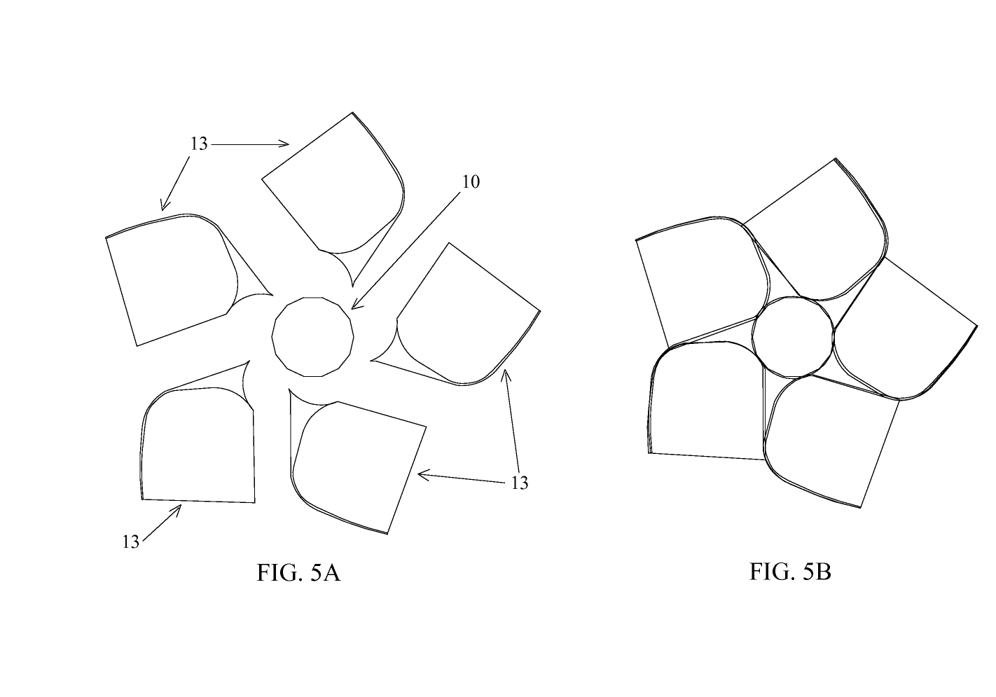

Next is referring to the Rotor 10 and Blade 13 assembly. FIG. 5A is an exploded overhead view of five Rotor Blades 13 and the Rotor 10. FIG. 5B is an overhead view of the Rotor and Blades showing the assembly points of the blades to each other and to the rotor.

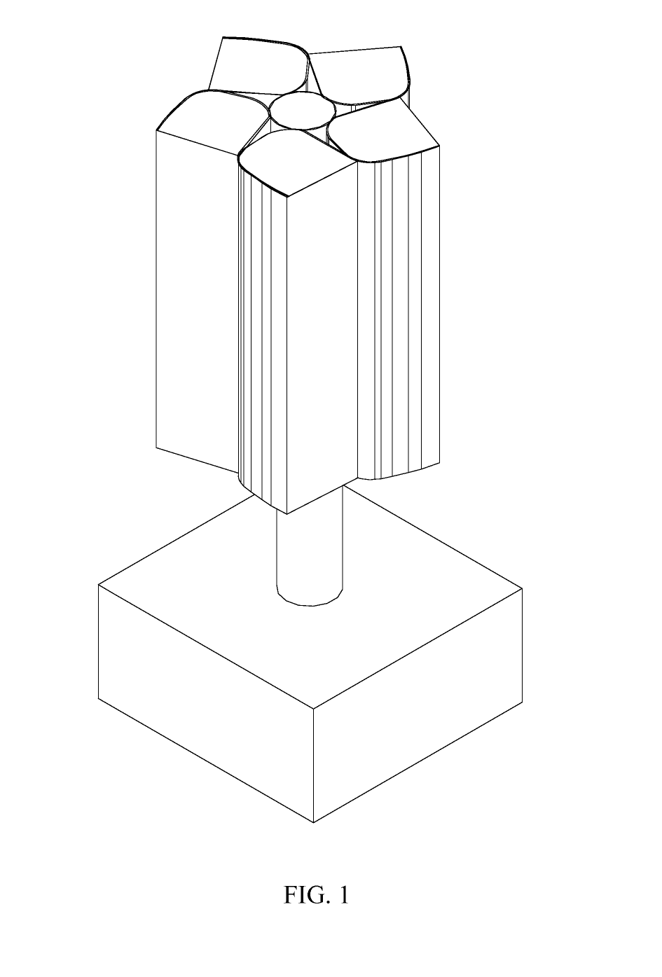

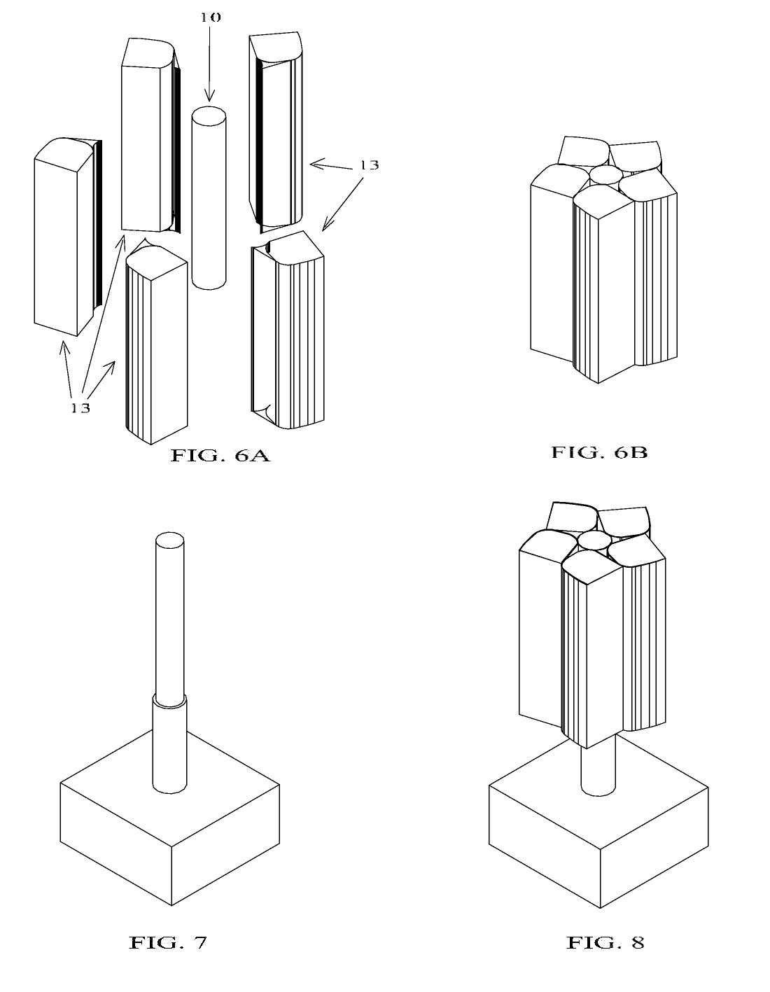

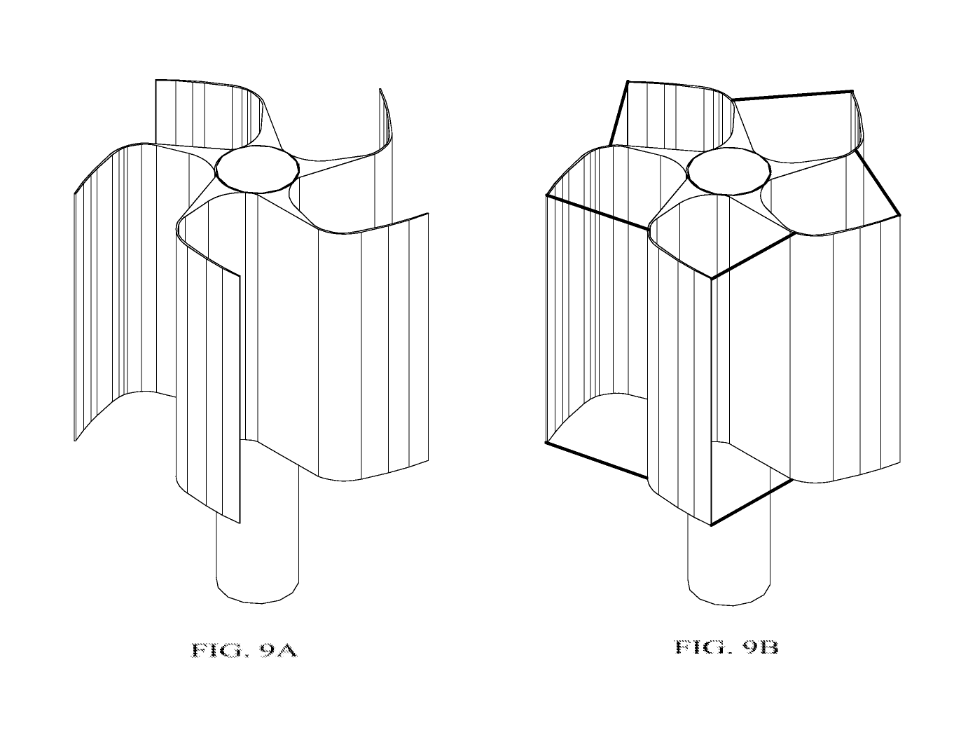

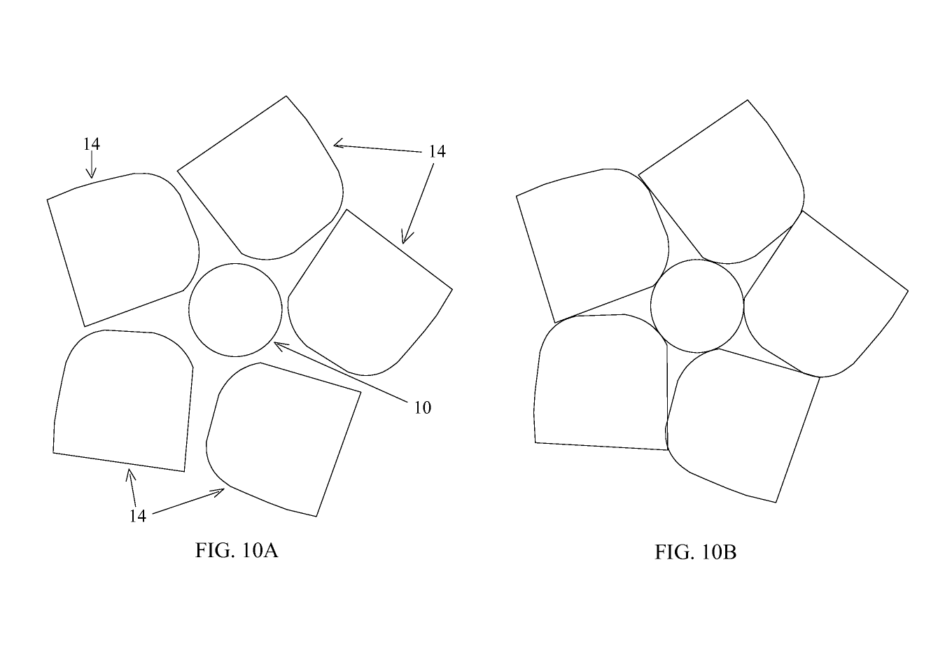

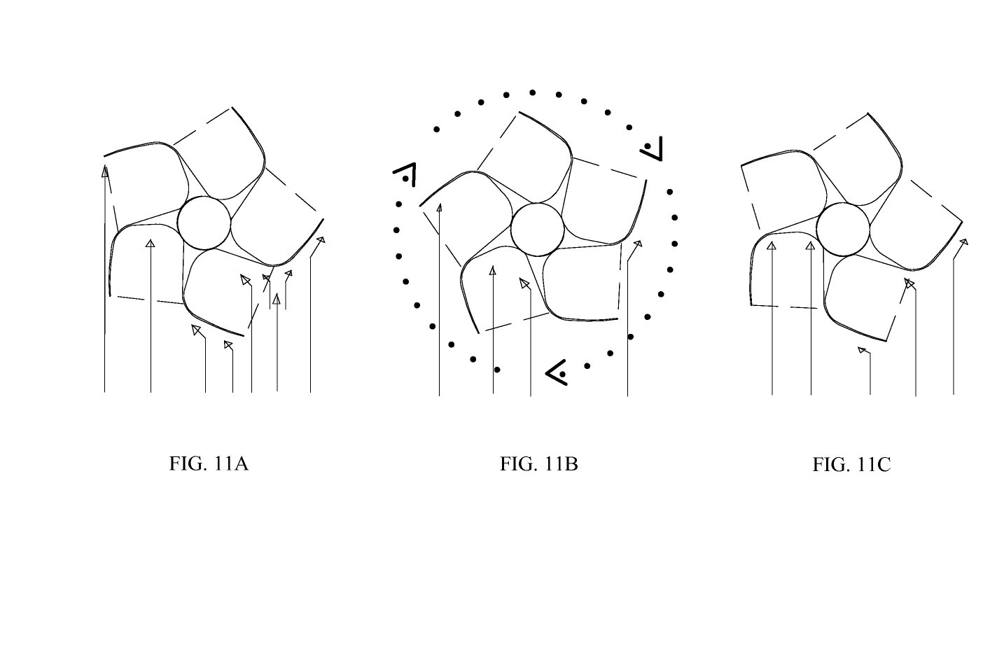

FIGS. 6A and 6B are isometric views of the assembly of the Blades 13 to the Rotor 10. FIG. 7 is an isometric view of the Base and Tower. The final assembly is to lower the Blade and Rotor assembly down over the Tower where it will seat onto the Mid-Section Bearings 7 and the Bearings 8 at the Tower top. At this point the Rotor Shaft 5 is connected to the Rotor Hub 9. FIGS. 8 and 1 show one embodiment of the completed Turbine.

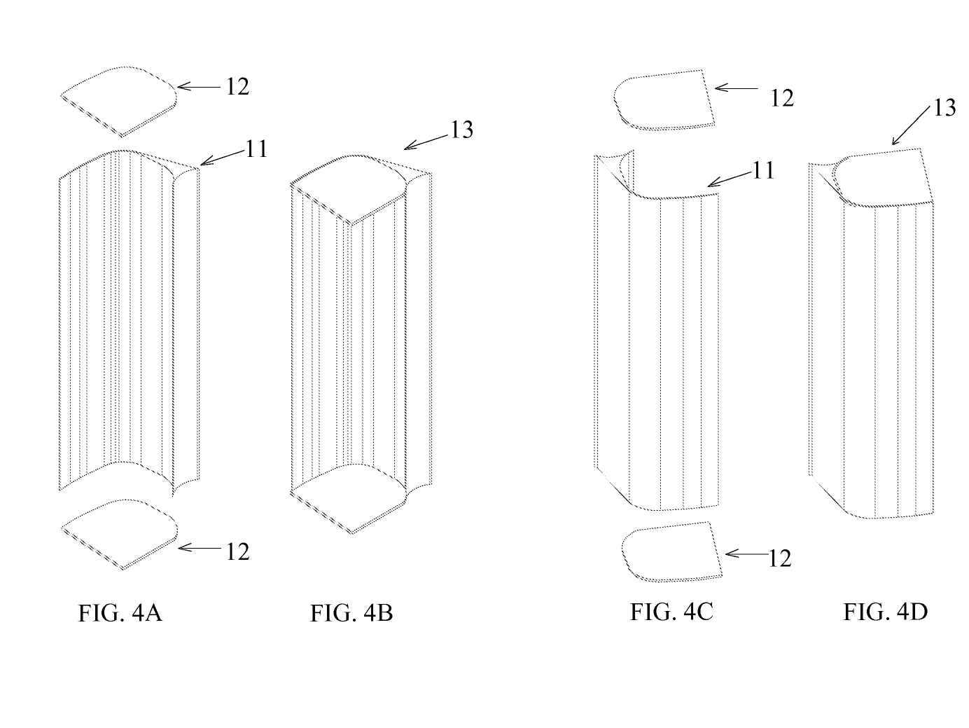

FIGS. 4A, 4B, 4C and 4D are two different angles of an isometric view as to the dimensional form and assembly of the Rotor Blades 13. The Blade 11 and End-caps 12 are shown in an exploded view. The Rotor Blades 13 have an elongated concave face side, that being the power side. The power side captures the wind or water currents creating compressible flow that is converted to torque to power the generators. The top and bottom End-Caps 12 keep the wind or water from being deflected out through the top and bottom of the Rotor Blades 13 thus increasing compressible flow. The back side, or return side has a multifaceted shape. The shape of the return side is engineered to deflect the currents in different directions at different angles of contact to reduce drag and increase compressible flow.

Fluid Dynamics: FIGS. 11A, 11B and 11C are three overhead views of the Omnidirectional Hybrid Turbine, each at slightly different rotation points. The lines with arrows represent wind or water direction and the deflection angles off of various points of the blades. FIG. 11B shows the rotational direction of the Rotor Blades 13 represented by the circular dotted lines with arrows. The dashed lines represent a transparent view through the End-Caps 12.

The above described embodiments of the Omnidirectional Hybrid Turbine provide numerous advantages over prior art wind turbines. For example, the invention's turbine tower and base can house multiple generators providing for an increased order of magnitude in electrical generation than currently possible by any single prior art wind turbine. The generators are selectively active relative to wind or water conditions to allow for optimal generating performance.

Also, except for the rotor blade assembly, all moving parts and electrical systems are enclosed in the tower and base, sheltered from all outdoor elements such as dirt, wind, rain, snow and ice.

One of the significant features of the invention is the dimensional shape of the blades, the length, height, depth and the configuration of the rotor blade assembly. In the configuration presented here, the 5 blades work in concert to continuously deflect currents into the face, or power side of the blades while also deflecting flow/currents away from the return (back) side of the blades. This produces maximum compressible flow on the power side of the blade and minimizes drag on the return side of the blades as depicted in FIGS. 11A, 11B and 11C.

What's different is all other wind turbines are designed to produce power by deflecting the wind off of the blades. This invention produces power by deflecting the wind or water currents into the blades, thus capturing more of the wind or water power by magnifying compressible flow acting upon the turbine blades.

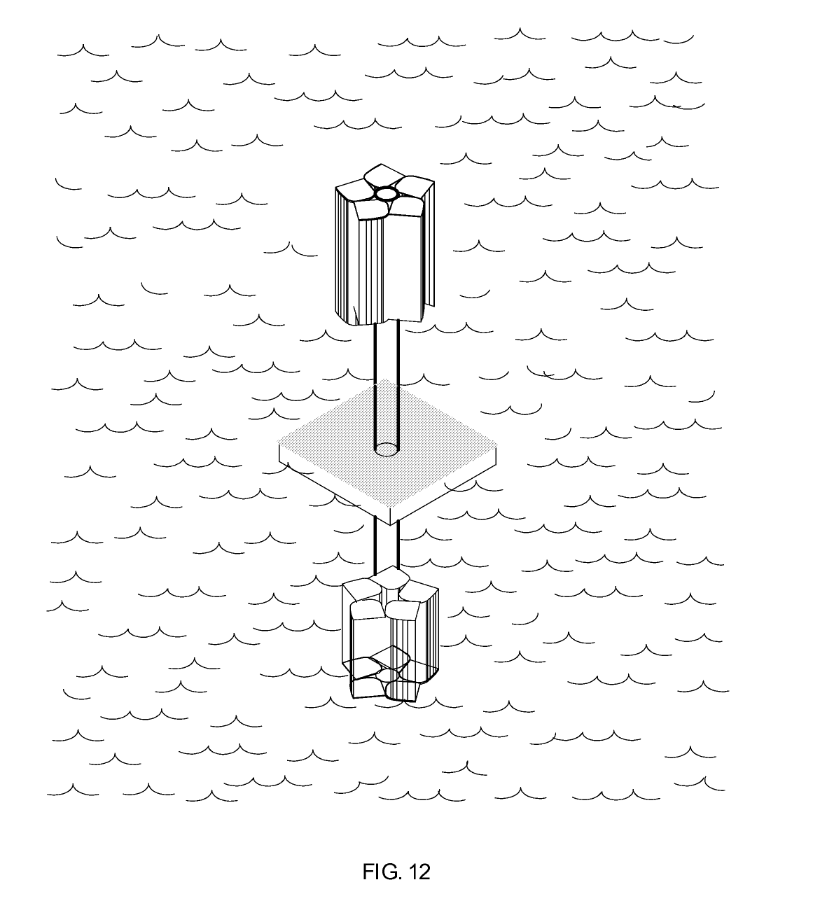

The omnidirectional turbine blades do not have to continuously make multiple adjustments to find the optimal wind direction and blade angle, it is always at the optimal performance provided by the wind or water currents. Also, they are more versatile on where they can be used; on land, in ocean currents, tidal currents or wave turbulence, even in river currents. Or, if preferred, on a floating platform on the water, see FIG. 12. Why use only one side of the platform when you can use two with a Dual Omnidirectional Hybrid Floating Turbine. The two turbines rotate in opposite directions to counter balance the torque upon the platform.

The invention claimed is:

1. An Omnidirectional Hybrid Turbine Generator comprising of: a base for the turbine; one or more generators, electronic systems and a brake; a tower with one or more generators and electrical wiring; a rotor shaft; bearings and seals for the mid-section and top of tower; a rotor hub; a rotor blade assembly consisting of a rotor and rotor blades wherein: the rotor blade assembly has the relative dimensional form as presented herein.

2. The Omnidirectional Hybrid Rotor Blade Assembly comprising of: The rotor and blades assembled as having the relative dimensional form as presented herein.

3. The Omnidirectional Hybrid Rotor Blade Assembly according to claim 2 wherein: the blades, having the relative dimensional form as presented and described herein as; The Rotor Blades have an elongated concave face side, that being the power side with the tops and bottoms having capped ends, and the back side as having a multifaceted shape as presented herein.

4. The Turbine Tower and Base as configured to house all equipment required for electricity generation and connection to the electrical grid comprising of; one or more generators in the base; a brake; a tower with one or more generators and electrical wiring; a rotor shaft; bearings and seals for the mid-section and top of tower; and a rotor hub and rotor.

5. The Turbine Tower according to claim 4 wherein: The Turbine Tower is configured to house all equipment required for electricity generation and connection to the electrical grid, including; one or more generators, a brake, electrical wiring, rotor shaft; bearings and seals for the mid-section and top of tower, a rotor shaft, rotor and hub.

6. The Omnidirectional Hybrid Turbine Generator according to claim 1 wherein: there is a floating platform with one Omnidirectional wind Turbine mounted to the top side of the platform and one Omnidirectional water Turbine mounted to the bottom side of the platform.
